(19) United States
(12) Patent Application Publication
(10) Pub. No.: US 2026/0132654 A1
(43) Pub. Date: May 14, 2026

(54) ELECTRONIC PADLOCK

(71) Applicant: Rosy Christensen, Carson, CA (US)

(72) Inventor: Rosy Christensen, Carson, CA (US)

(21) Appl. No.: 18/941,668

(22) Filed: Nov. 8, 2024

(51) Int. Cl. E05B 49/00

(52) U.S. Cl. CPC E05B 49/00; E05B 67/22

(57) ABSTRACT

An electronic padlock includes a lock body and a shackle having a long leg and a short leg. A lock arm is designed to engage and retain the short leg in the lock body. A drive unit can move the lock arm out to release the short leg. A transceiver is designed to wirelessly receive a numeric combination from an electronic device and then transmit the numeric combination to a microprocessor to activate the drive unit. A rotary dial is positioned projects out through a front aperture in a front wall of the lock body. The rotary dial includes a disc and a knob projecting from the disc. The disc includes a plurality of numbers thereon. The rotary dial is selectively rotatable to enter the numeric combination. The rotary dial is connected to the microprocessor to transmit the numeric combination to the microprocessor to activate the drive unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electronic locks and more particularly pertains to a new electronic padlock that incorporates a rotary dial with electronic locking features. Padlocks are well known and used everywhere to secure two components together, such as a door to a door frame, by running a curved shackle through a corresponding pair of openings and then inserting the short leg of the shackle into the lock body. A rotary dial is used to enter usually a three-digit numeric combination to align three corresponding internal cams to release the short leg for opening. Electronic locks are also well known and usually use a numeric combination entered via a keypad or wirelessly or biometrically to activate an electromechanical locking mechanism. However, no electronic padlock exists that provides the user with the familiarity of a rotary dial and the security of an electronic lock.

### (2) Description of Related Art Including Information Disclosed under 37 CFR 1.97 and 1.98

The prior art relates to electronic locks. The prior art, as best understood, does not disclose electronic padlock that includes rotary dial and a lock arm driven by a drive unit controlled by a microprocessor, wherein a numeric combination can be entered wirelessly or via the rotary dial.

### BRIEF SUMMARY OF THE INVENTION

An embodiment of the disclosure meets the needs presented above in a electronic padlock generally comprising a lock body having a front wall, a rear wall, a top wall, a bottom wall, and two side walls together defining an interior cavity. A shackle is coupled to the lock body. The shackle includes a long leg and a short leg inserted into respective top apertures in the top wall. The short leg is movable into and out of the lock body to lock and unlock the shackle. A lock arm is positioned in the interior cavity. The lock arm is designed to engage the short leg to retain the short leg in the interior cavity. A drive unit is positioned in the interior cavity. The drive unit is connected to the lock arm to move the lock arm out of engagement with the short leg to release the short leg. A microprocessor is positioned in the interior cavity. The microprocessor is connected to the drive unit to activate the drive unit. A transceiver is positioned in the interior cavity. The transceiver is connected to the microprocessor. The transceiver is designed to wirelessly receive a numeric combination from an electronic device and then transmit the numeric combination to the microprocessor to activate the drive unit. A battery is positioned in the interior cavity. The battery is connected to the microprocessor to supply power to the microprocessor, the transceiver, and the drive unit. A rotary dial is positioned in the interior cavity and projects out through a front aperture in the front wall. The rotary dial includes a disc and a knob projecting from the disc. The disc includes a plurality of numbers thereon. The rotary dial is selectively rotatable to enter the numeric combination. The rotary dial is connected to the microprocessor to transmit the numeric combination to the microprocessor to activate the drive unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an electronic padlock according to an embodiment of the disclosure in use.

FIG. 2 is a top front perspective view of an embodiment of the disclosure.

FIG. 3 is a bottom rear perspective view of an embodiment of the disclosure.

FIG. 4 is a side view of an embodiment of the disclosure.

FIG. 5 is a front view of an embodiment of the disclosure.

FIG. 6 is a front view of an embodiment of the disclosure.

FIG. 7 is a block diagram of components of an embodiment of the disclosure.

### DETAILED DESCRIPTION OF THE INVENTION

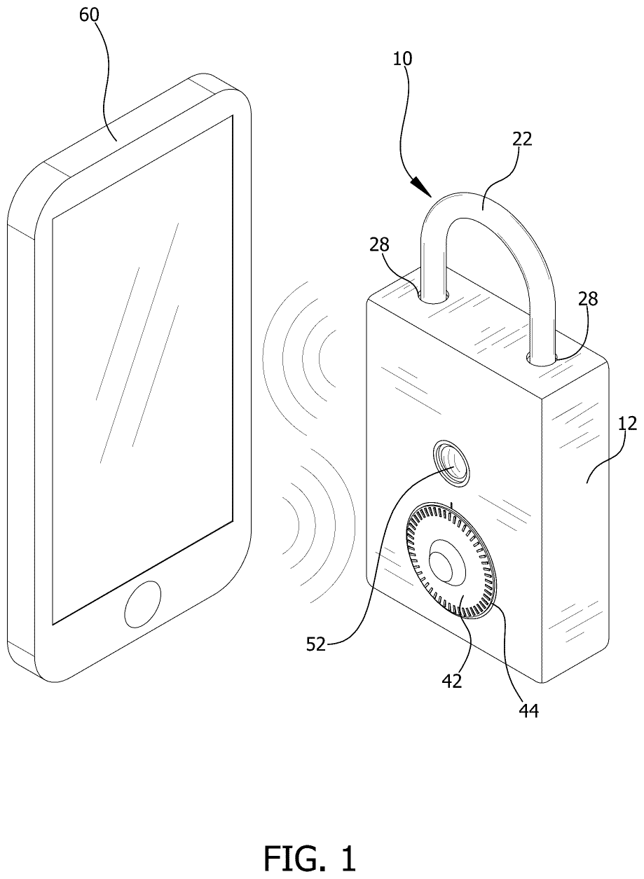

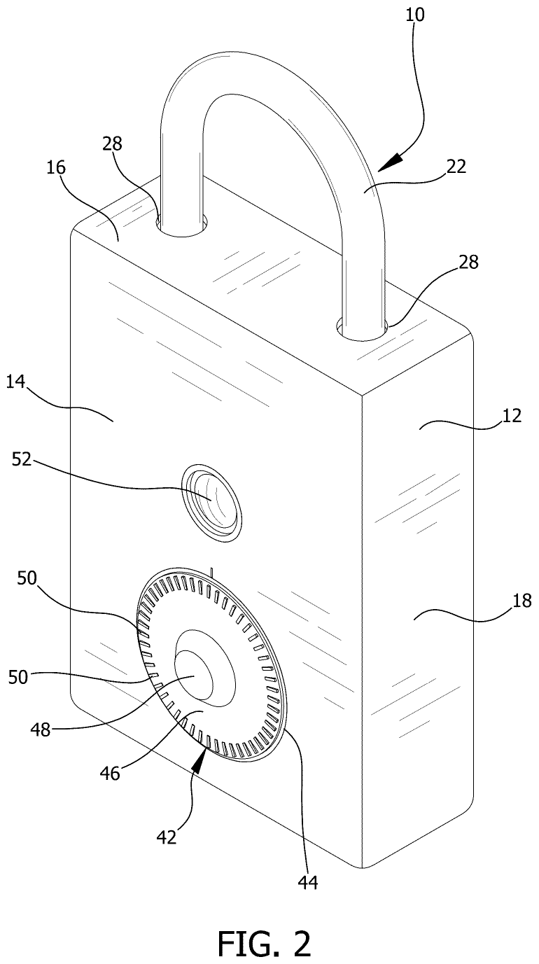

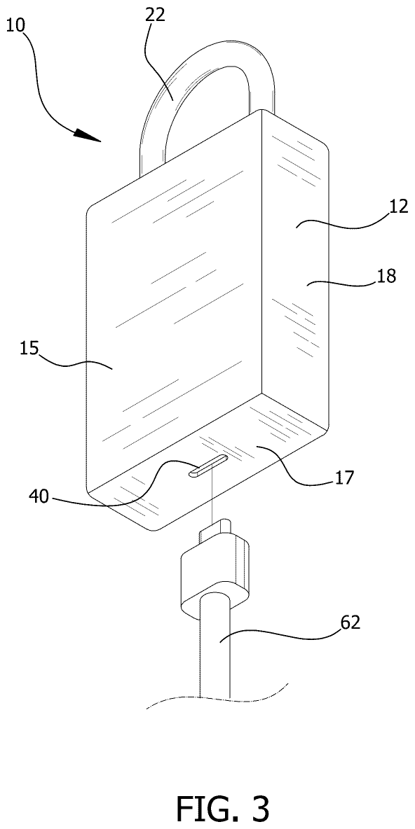

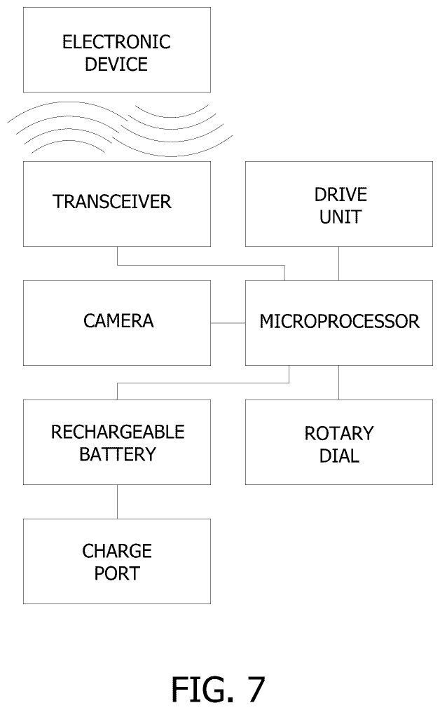

With reference now to the drawings, and in particular to FIGS. 1 through 7 thereof, a new electronic padlock embodying the principles and concepts of an embodiment of the disclosure and generally designated by the reference numeral 10 will be described.

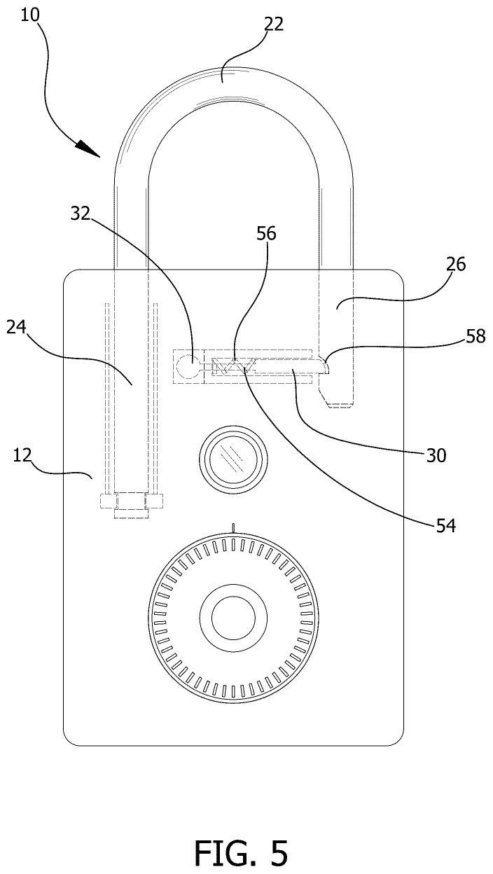

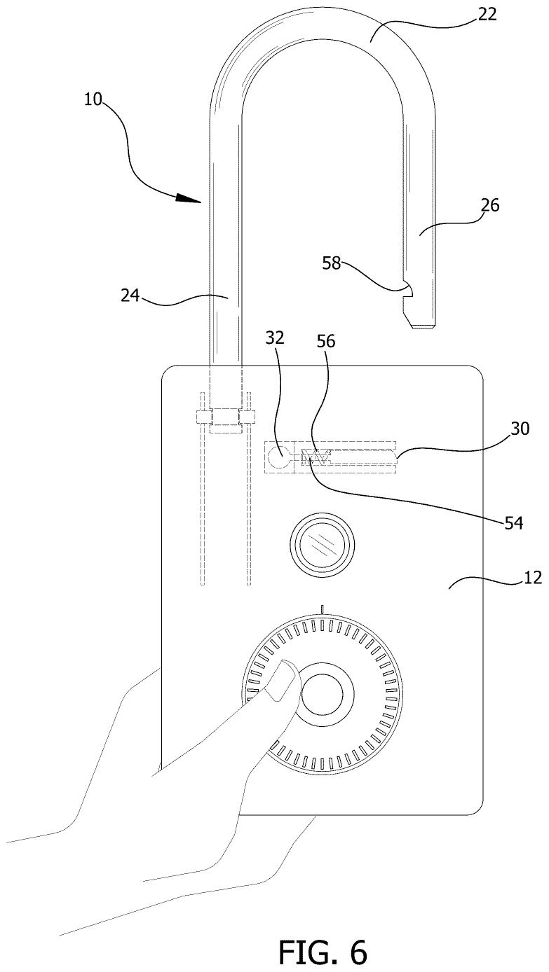

As best illustrated in FIGS. 1 through 7, the electronic padlock 10 generally comprises a lock body 12 having a front wall 14, a rear wall 15, a top wall 16, a bottom wall 17, and two side walls 18 together defining an interior cavity 20. A shackle 22 is coupled to the lock body 12. As best seen in FIGS. 5 and 6, the shackle 22 includes a long leg 24 and a short leg 26 inserted into respective top apertures 28 in the top wall 16. The short leg 26 is movable into and out of the lock body 12 to lock and unlock the shackle 22. A lock arm 30 is positioned in the interior cavity 20. The lock arm 30 is designed to engage the short leg 26 to retain the short leg 26 in the interior cavity 20, such as by projecting into a catch in the short leg 26.

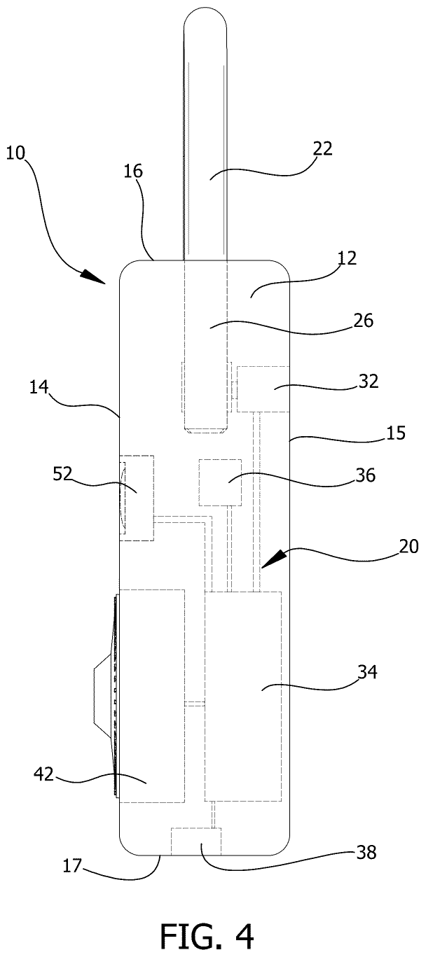

A drive unit 32 is positioned in the interior cavity 20. The drive unit 32 can be a rotary motor or screw drive. The drive unit 32 is connected to the lock arm 30 to move the lock arm 30 out of engagement with the short leg 26 to release the short leg 26. As best seen in FIG. 4, a microprocessor 34 is positioned in the interior cavity 20. The microprocessor 34 is connected to the drive unit 32 to activate the drive unit 32. A transceiver 36 is positioned in the interior cavity 20. The transceiver 36 is connected to the microprocessor 34. The transceiver 36 is designed to wirelessly receive a numeric combination from an electronic device 60, such as a smartphone shown in FIG. 1, and then transmit the numeric combination to the microprocessor 34 to activate the drive unit 32. A battery 38 is positioned in the interior cavity 20. The battery 38 is connected to the microprocessor 34 to supply power to the microprocessor 34, the transceiver 36, and the drive unit 32. The battery 38 is rechargeable and includes a charging port 40 positioned in the bottom wall 17, to which can be connected a charging cable 62, such as a USB-style charger.

A rotary dial 42 is positioned in the interior cavity 20 and projects out through a front aperture 44 in the front wall 14. The rotary dial 42 includes a disc 46 and a knob 48 projecting from the disc 46. The disc 46 includes a plurality of numbers 50 thereon, which are shown in the figures as small marks rather than actual numbers for clarity. The rotary dial 42 is selectively rotatable to enter the numeric combination, as with most padlocks. However, the rotary dial 42 is connected to the microprocessor 34 to transmit the numeric combination to the microprocessor 34 to activate the drive unit 32. In this manner, an owner of the electronic padlock 10 can enter the numeric combination in the manner of traditional padlocks, but with an electronic control. The microprocessor 34 is programmable to set any numeric combination the user desires to set.

The electronic padlock 10 further includes a camera 52 that is mounted in the front wall 14. The camera 52 is connected to the microprocessor 34 to transmit visual images to the microprocessor 34. The microprocessor 34 is designed to transmit the visual images wirelessly via the transceiver 36. The camera 52 provides another layer of security in the event another party wishes to tamper with the electronic padlock 10, as the owner can receive images of the other party. The microprocessor 34 could be programmed to send an alert to the electronic device 60 if images of a person are recorded.

In one possible embodiment, the microprocessor 34 is programmable to wirelessly transmit an alert to the electronic device 60 when an incorrect numeric combination is entered via the rotary dial 42. For example, if another party tries to open the electronic padlock 10 by guessing the numeric combination, the owner would be alerted of the entry of the incorrect values as a sign that the other party is trying to guess the numeric combination. In another possible embodiment, the microprocessor 34 is also programmable to wirelessly transmit an alert to the electronic device 60 when the rotary dial 42 is rotated to enter the numeric combination during a selected time period. For example, if the owner will be away from the electronic padlock 10 for a particular time, such as during a work shift or at school classes, the owner can be alerted that another party is trying to access the electronic padlock 10 when the owner is not around. Consequently, even if the other party has the correct numeric combination, the owner can still be alerted that someone is trying to open the padlock, possibly without the owner's permission.

In use, as shown in FIGS. 5 and 6, the user inserts the short leg 26, which displaces the lock arm 30 along a connector 54, which is connected to the drive unit 32. In the exemplary embodiment, a spring 56 biases the lock arm 30 into a catch 58 in the short leg 26. When the drive unit 32 is activated by entry of the numeric combination, the drive unit 32 retracts the connector 54 which retracts the lock arm 30 against the spring 56. After a set period of time, or possibly upon rotation of the rotary dial, the microprocessor 34 reverses the drive unit 32, which releases the lock arm 30 to be biased by the spring 56 again. It should be understood that the exemplary embodiment shows one possible design of the lock arm 30 and drive unit 32, and other possible designs are within the scope of the disclosure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic padlock comprising:
a lock body having a front wall, a rear wall, a top wall, a bottom wall, and two side walls together defining an interior cavity;
a shackle coupled to said lock body, said shackle including a long leg and a short leg inserted into respective top apertures in said top wall, said short leg being movable into and out of said lock body to lock and unlock said shackle;
a lock arm being disposed in said interior cavity, said lock arm being configured to engage said short leg to retain said short leg in said interior cavity;
a drive unit being disposed in said interior cavity, said drive unit being connected to said lock arm to move said lock arm out of engagement with said short leg to release said short leg;
a microprocessor being disposed in said interior cavity, said microprocessor being connected to said drive unit to activate said drive unit;
a transceiver being disposed in said interior cavity, said transceiver being connected to said microprocessor, said transceiver being configured to wirelessly receive a numeric combination from an electronic device and then transmit the numeric combination to said microprocessor to activate said drive unit;
a battery being disposed in said interior cavity, said battery being connected to said microprocessor to supply power to said microprocessor, said transceiver, and said drive unit; and
a rotary dial being disposed in said interior cavity and projecting out through a front aperture in said front wall, said rotary dial including a disc and a knob projecting from said disc, said disc including a plurality of numbers thereon, said rotary dial being selectively rotatable to enter the numeric combination, said rotary dial being connected to said microprocessor to transmit said numeric combination to said microprocessor to activate said drive unit.

2. The electronic padlock of claim 1, further comprising a camera being mounted in said front wall, said camera being connected to said microprocessor to transmit visual images to said microprocessor, wherein said microprocessor is configured to transmit visual images wirelessly via said transceiver.

3. The electronic padlock of claim 1, wherein said microprocessor is programmable to wirelessly transmit an alert to the electronic device when an incorrect numeric combination is entered via said rotary dial.

4. The electronic padlock of claim 1, wherein said microprocessor is programmable to wirelessly transmit an alert to the electronic device when said rotary dial is rotated to enter said numeric combination during a selected time period.

5. The electronic padlock of claim 1, wherein said battery is rechargeable and includes a charging port disposed in said bottom wall.

6. The electronic padlock of claim 2, wherein said microprocessor is programmable to wirelessly transmit an alert to the electronic device when an incorrect numeric combination is entered via said rotary dial.

7. The electronic padlock of claim 6, wherein said microprocessor is programmable to wirelessly transmit an alert to the electronic device when said rotary dial is rotated to enter said numeric combination during a selected time period.

8. The electronic padlock of claim 7, wherein said battery is rechargeable and includes a charging port disposed in said bottom wall.
